(19) United States
(12) Patent Application Publication
(10) Pub. No.: US 2022/0130588 A1
(43) Pub. Date: Apr. 28, 2022

(54) REACTOR AND ELECTRIC POWER CONVERSION DEVICE

(71) Applicant: Panasonic Intellectual Property Management Co., Ltd., Osaka (JP)

(72) Inventors: TOSHIYUKI ASAHI, Osaka (JP); JUNICHI KOTANI, Hyogo (JP); SHIGEYUKI INAGAKI, Hyogo (JP)

(21) Appl. No.: 17/428,305

(22) PCT Filed: Mar. 19, 2020
(86) PCT No.: PCT/JP2020/012320

§ 371 Date: Aug. 4, 2021

(30) Foreign Application Priority Data
Mar. 29, 2019 (JP) 2019-069214

(51) Int. Cl. H01F 27/24; H01F 37/00; H01F 30/12; H01F 27/28

(52) U.S. Cl. CPC H01F 27/24; H01F 27/2828; H01F 30/12; H01F 37/00

(57) ABSTRACT

A reactor includes a core and first to fourth coils wound around the core and magnetically coupled to one another. A coupling coefficient K12 between the first and second coils, a coupling coefficient K13 between the first and third coils, and a coupling coefficient K14 between the first and fourth coils satisfy relations K13>K12 and K13>K14; and a coupling coefficient K23 between the second and third coils, a coupling coefficient K24 between the second and fourth coils, and a coupling coefficient K34 between the third and fourth coils satisfy relations K24>K23 and K24>K34. Alternatively, n the core, a width of a first core part in a second direction is shorter than a width of the first core part in a third direction, a width of a second core part in the second direction is shorter than a width of the second core part in a third direction, a width of a third core part in the second direction is shorter than a width of a third shaft in the third direction, and a width of a fourth core part in the second direction is shorter than a width of the fourth core part in a third direction. Alternatively, a straight line crossing respective center axes of the first and fourth coils crosses a straight line crossing respective center axes of the second and third coils at a column part of the core when viewed in the first direction. This reactor hardly decrease an electric power conversion efficiency even at low load.

### TECHNICAL FIELD

The present disclosure relates to a reactor including a core, and an electric power conversion device including the reactor.

### BACKGROUND ART

A conventional composite transformer (reactor) including a single transformer and plural inductors is disclosed in, for example, PTL 1.

PTL 1 discloses a three-phase magnetic coupling reactor including three-phase reactors magnetically coupled to one another. The three-phase magnetic coupling reactor includes a triaxial core, three phase coils, and a hexahedral core. The triaxial core includes protrusions extended along three axes orthogonal to one another and protruding from the center toward the six directions, respectively. Each of the three phase coils is wound around respective axis of the triaxial core. The hexahedral core has a housing space therein accommodating the triaxial core around which the phase coils is wound, and has six inner wall surfaces facing six protruding portions of the triaxial core. PTL 1 discloses that this three-phase magnetic coupling reactor can improve occupation efficiency of the space.

### CITATION LIST

### Patent Literature

PTL 1: Japanese Patent Laid-Open Publication No. 2011-204946

### SUMMARY

A reactor includes a core and first to fourth coils wound around the core and magnetically coupled to one another. A coupling coefficient K12 between the first and second coils, a coupling coefficient K13 between the first and third coils, and a coupling coefficient K14 between the first and fourth coils satisfy relations K13>K12 and K13>K14; and a coupling coefficient K23 between the second and third coils, a coupling coefficient K24 between the second and fourth coils, and a coupling coefficient K34 between the third and fourth coils satisfy relations K24>K23 and K24>K34. Alternatively, n the core, a width of a first core part in a second direction is shorter than a width of the first core part in a third direction, a width of a second core part in the second direction is shorter than a width of the second core part in a third direction, a width of a third core part in the second direction is shorter than a width of a third shaft in the third direction, and a width of a fourth core part in the second direction is shorter than a width of the fourth core part in a third direction. Alternatively, a straight line crossing respective center axes of the first and fourth coils crosses a straight line crossing respective center axes of the second and third coils at a column part of the core when viewed in the first direction.

This reactor hardly decrease an electric power conversion efficiency even at low load.

### BRIEF DESCRIPTION OF DRAWINGS

FIG. 1A is a perspective view of a reactor in accordance with an exemplary embodiment of the present disclosure for transparently illustrating a part thereof.

FIG. 1B is a perspective view of the reactor in accordance with the embodiment.

FIG. 2 is a perspective view of a core of the reactor in accordance with the embodiment.

FIG. 3 is a sectional view of the core along line III-III shown in FIG. 2.

FIG. 4 is a sectional view of the reactor along line IV-IV shown in FIG. 1B.

FIG. 5A is a sectional view of the reactor along line VA-VA shown in FIG. 4.

FIG. 5B is a sectional view of the reactor along line VB-VB shown in FIG. 4.

FIG. 5C is a sectional perspective view of the reactor along line VC-VC shown in FIG. 4.

FIG. 6A is a sectional view of the reactor along line VIA-VIA shown in FIG. 4.

FIG. 6B is a sectional view of the reactor along line VIB-VIB shown in FIG. 4.

FIG. 6C is a sectional view of the reactor along line VIC-VIC shown in FIG. 4.

FIG. 7A is a side view of the reactor in accordance with the embodiment.

FIG. 7B is a front view of the reactor in accordance with the embodiment.

FIG. 8 is a circuit diagram of an electric power conversion device in accordance with the embodiment.

### DETAIL DESCRIPTION OF PREFERRED EMBODIMENT

Hereinafter, the exemplary embodiments of the present disclosure are described with reference to drawings. However, each of the following exemplary embodiments is only one of various exemplary embodiments of the present disclosure. The following exemplary embodiments can undergo various modifications depending on designs and the like as long as the object of the present disclosure can be achieved.

### (1) Outline

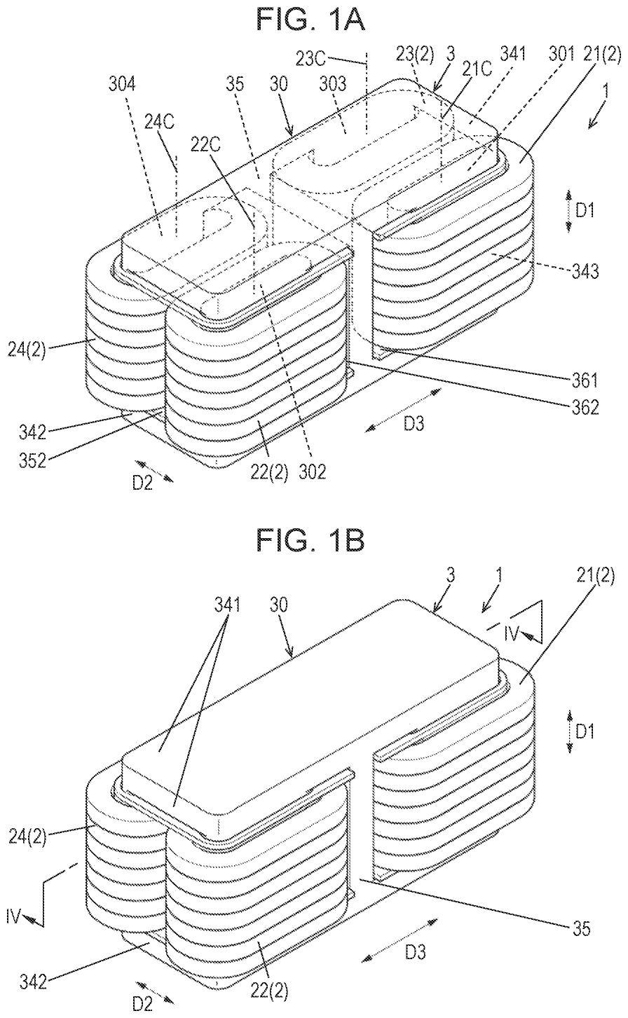

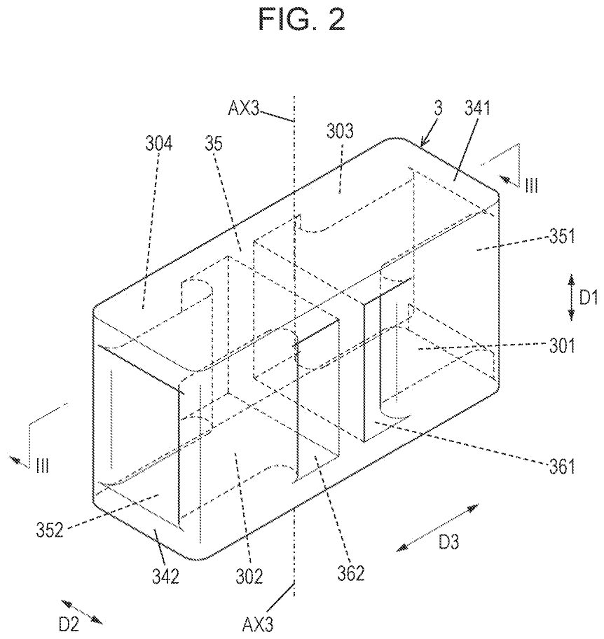

FIGS. 1A and 1B are perspective views of reactor 1 in accordance with an exemplary embodiment. FIG. 1A transparently shows a part of reactor 1. FIG. 2 is a perspective view of core 3 of reactor 1. Reactor 1 includes core 3 and plural coils 2 wound around core 3. The coils 2 includes four coils 21 to 24.

Reactor 1 in accordance with the embodiment is a multi-phase magnetic coupling reactor having two or more phases, and has a magnetic coupling function for magnetically coupling four coils 2 and an inductor function for storing magnetic energy.

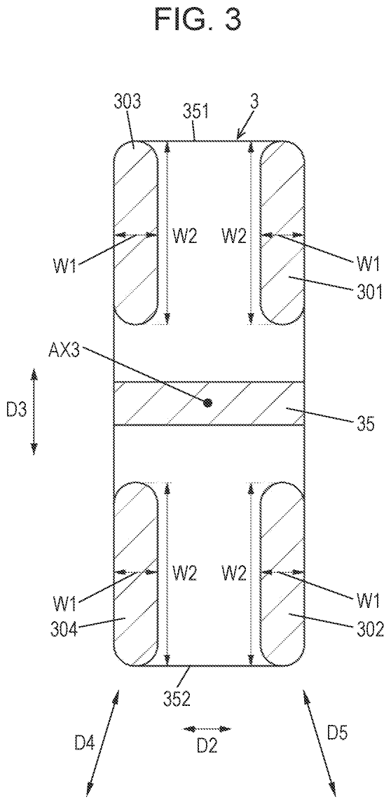

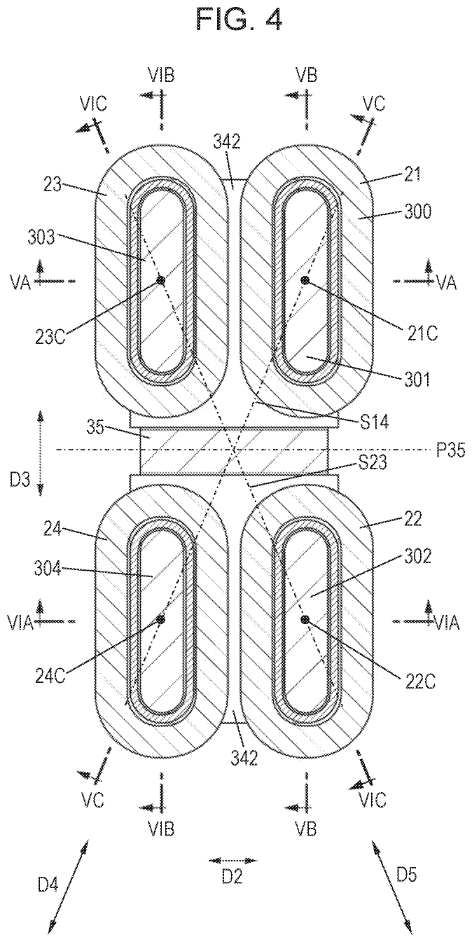

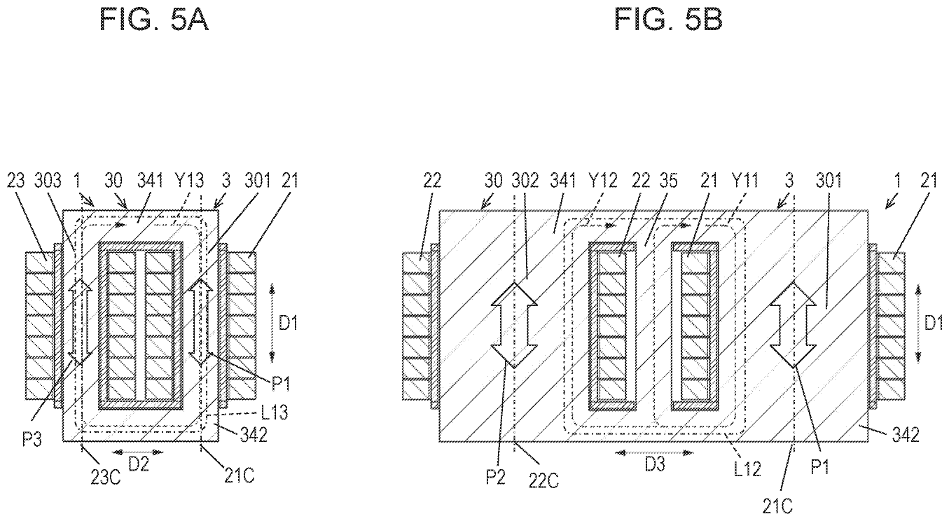

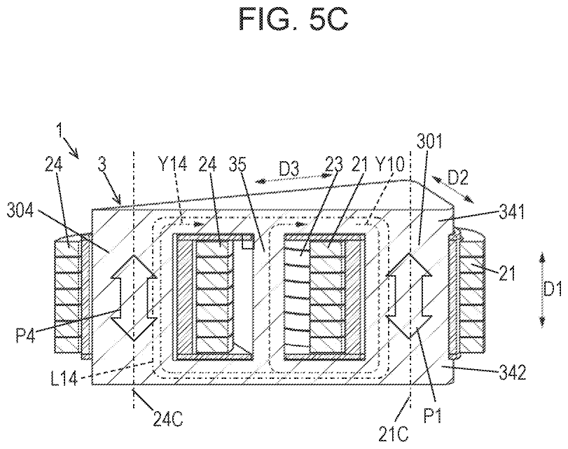

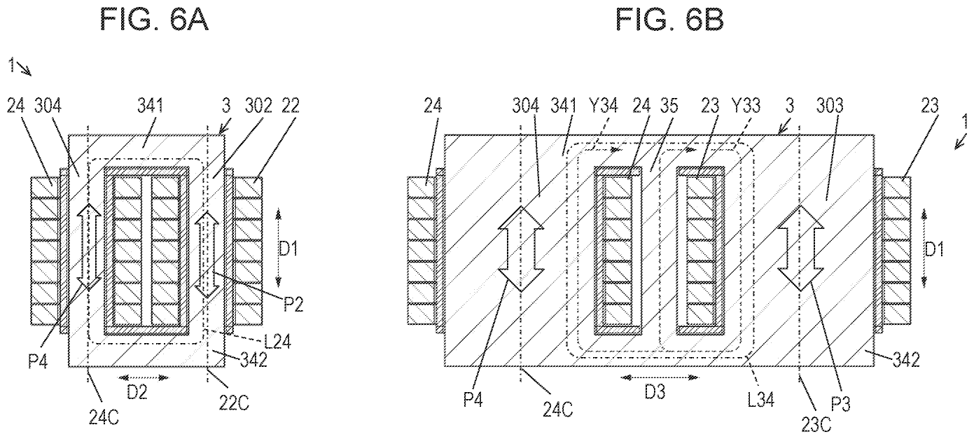

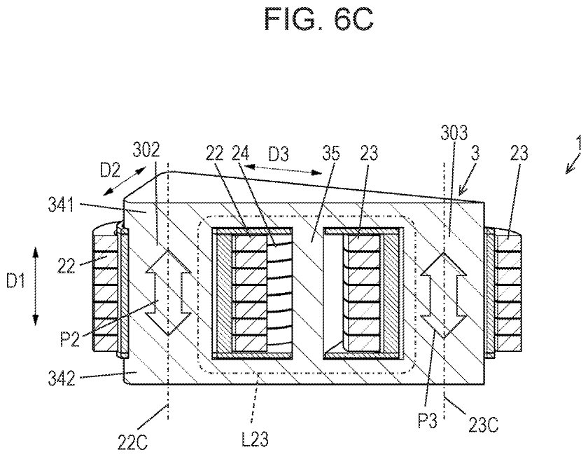

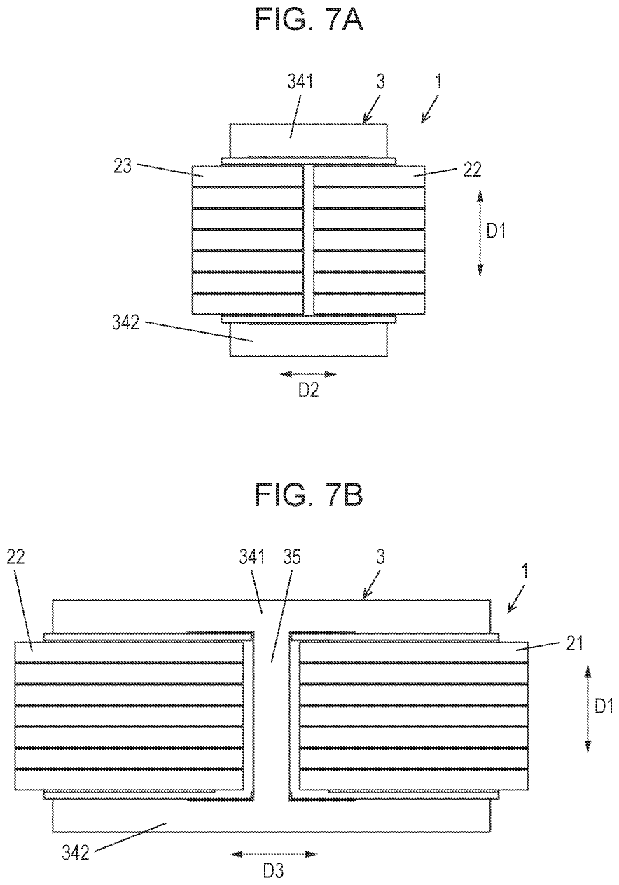

FIG. 3 is a sectional view of core 3 along line III-III shown in FIG. 2. FIG. 4 is a sectional view of reactor 1 along line IV-IV shown in FIG. 1B. FIG. 5A is a sectional view of reactor 1 along line VA-VA shown in FIG. 4. FIG. 5B is a sectional view of reactor 1 along line VB-VB shown in FIG. 4. FIG. 5C is a sectional perspective view of reactor 1 along line VC-VC shown in FIG. 4. FIG. 6A is a sectional view of reactor 1 along line VIA-VIA shown in FIG. 4. FIG. 6B is a sectional view of reactor 1 along line VIB-VIB shown in FIG. 4. FIG. 6C is a sectional view of reactor 1 along line VIC-VIC shown in FIG. 4. FIGS. 7A and 7B are a side view of the reactor in accordance with the embodiment.

Core 3 has a rectangular frame shape. Four coils 2 (21 to 24) are wound around cores 3. Core 3 forms a magnetic path, and magnetically couples two or more coils 2 to one another. Core 3 is configured to store magnetic fluxes generated when electric currents flows in coils 2 as magnetism energy. Core 3 may form a closed magnetic path, or an open magnetic path rather which is not a closed magnetic path.

As shown in FIGS. 5A-5C and FIGS. 6A-6C, core 3 includes plural coupling magnetic paths. In detail, core 3 includes coupling magnetic path L12 passing through the inside of coil 21 and the inside of coil 22, coupling magnetic path L13 passing through the inside of coil 21 and the inside of coil 23, and coupling magnetic path L14 passing through the inside of coil 21 and the inside of coil 24. Core 3 further includes coupling magnetic path L23 passing through the inside of coil 22 and the inside of coil 23, and coupling magnetic path L24 passing through the inside of coil 22 and the inside of coil 24. Core 3 further includes coupling magnetic path L34 passing through the inside of coil 23 and the inside of coil 24.

In reactor 1 in accordance with the embodiment, a coupling coefficient K12 between coil 21 and coil 22, a coupling coefficient K13 between coil 21 and coil 23, and a coupling coefficient K14 between coil 21 and coil 24 satisfy the relations expressed as the following formula (1).

K13>K12 and K13>K14 (1)

In reactor 1, a coupling coefficient K23 between coil 22 and coil 23, a coupling coefficient K24 between coil 22 and coil 24, and a coupling coefficient K34 between coil 23 and coil 24 satisfy the relations expressed as the following formula (2).

K24>K23 and K24>K34 (2)

In reactor 1 in accordance with this exemplary embodiment in which since the coupling coefficients K12, K13, K14, K23, K24, and K34 satisfy the above relations hardly allows electric power conversion efficiency to deteriorate even in a two-phase drive mode where electric currents flow only in two coils 2 out of coils 21, 22, 23, and 24. This is because two coils having a high coupling coefficient provides reactor 1 with a high direct-current (DC) superimposition effect even when reactor 1 is driven in two phases. Therefore, even when reactor 1 does not allow an electric current to flow in one or more coils 2 among plural coils 2, that is, even when reactor 1 is driven at low load, reactor 1 prevents electric power conversion efficiency from deteriorating. Even when reactor 1 in accordance with the embodiment is driven in four phases at high load, that is, reactor 1 is driven by allowing electric currents in coils 21, 22, 23, and 24, a switching loss of the semiconductor switch does not easily occur. Therefore, reactor 1 achieves an effect of magnetic coupling even if a large electric current flows, so that a high DC superimposition effect can be obtained. Therefore, reactor 1 achieves high electric power conversion efficiency. The DC superimposition effect allows reactor 1 to provide an effect that an inductance is not easily reduced.

A loss of an electric power conversion device includes a loss generated even without load, for example, a loss caused by switching, and a loss due to load. A multi-phase driven electric power conversion device may improve the efficiency by reducing the number of coils for driving by allowing an electric current to flow at low load (hereinafter, referred to as “number of driving phases”) to reduce a no-load loss. A multi-phase coupling reactor improves direct current superposition characteristics or reduce in size by cancelling magnetic fluxes by DC electric current. However, in the reactor disclosed in PTL 1, in a case of low load, when the number coils to be driven by allowing an electric current to flow is accordingly reduced, magnetic fluxes are cancelled insufficiently, direct current superposition characteristics may be deteriorated, and electric power conversion efficiency may be deteriorated.

In contrast, as described above, reactor 1 in accordance with the embodiment prevents electric power conversion efficiency from deteriorating even when the number of driving phases is reduced, that is, even when reactor 1 is driven at low load.

The coupling coefficient means a coupling coefficient of magnetic coupling between two coils. The coupling coefficient K12 of magnetic coupling between coils 21 and 22 is a rate of magnetic fluxes passing through coupling magnetic path L12 among all magnetic fluxes generated by coil 21 relative to the all magnetic fluxes. The coupling coefficient K13 of magnetic coupling between coils 21 and 23 is a rate of magnetic fluxes passing through coupling magnetic path L13 among all magnetic fluxes generated by coil 21 relative to the all magnetic fluxes. The coupling coefficient K14 of magnetic coupling between coils 21 and 24 is a rate of magnetic fluxes passing through coupling magnetic path L14 among all magnetic fluxes generated by coil 21 relative to the all magnetic fluxes. The coupling coefficient K23 of magnetic coupling between coils 22 and 23 is a rate of magnetic fluxes passing through coupling magnetic path L23 among all magnetic fluxes generated by coil 22 relative to the all magnetic fluxes. The coupling coefficient K24 of magnetic coupling between coils 22 and 24 is a rate of magnetic a flux passing through coupling magnetic path L24 among all magnetic fluxes generated by coil 22 relative to the all magnetic fluxes. The coupling coefficient K34 of magnetic coupling between coils 23 and 24 is a rate of magnetic fluxes passing through coupling magnetic path L34 among all magnetic fluxes generated by coil 24 relative to the all magnetic fluxes.

### (2) Details

### (2-1) Reactor

A configuration of reactor 1 in accordance with the embodiment will be detailed below with reference to FIGS. 1A-7B. FIGS. 1A-7B schematically show coils 2 (coils 21, 22, 23, and 24), and the number of windings in the drawing may be different from actual number of windings. In FIGS. 1A-7B, both ends of each of coils 2 (coils 21, 22, 23, and 24) are omitted.

Coils 21, 22, 23, and 24 as four coils 2 are wound about center axes 21C, 22C, 23C, and 24C, respectively. Center axes 21C, 22C, 23C, and 24C are extended in direction D1. Coils 21 and 23 are arranged in direction D2 perpendicular to direction D1. Coils 22 and 24 are arranged in direction D2. Coils 21 and 22 are arranged in direction D3 perpendicular to directions D1 and D2. Coils 23 and 24 are arranged in direction D3.

Firstly, a structure of core 3 will be described with reference to FIG. 2. Core 3 includes core parts 301, 302, 303, and 304, connection parts 341 and 342, and column part 35. As shown in FIG. 2, core parts 301, 302, 303 and 304, and column part 35 are extended along direction D1. Core parts 301 and 303 are arranged in direction D2. Core parts 302 and 304 are arranged in direction D2. Core parts 301 and 302 are arranged in direction D3. Core parts 303 and 304 are arranged in direction D3. Column part 35 is disposed from a position between core part 301 and core part 303 to a position between core part 302 and core part 304. Column part 35 and core part 301 are arranged in a direction perpendicular to direction D1.

Connection parts 341 and 342 are arranged along direction D1 with a space in between. Respective one ends of core parts 301, 302, 303 and 304 and column part 35 along direction D1 are connected to connection part 341. Respective another ends of core parts 301, 302, 303 and 304 and column part 35 along direction D1 are connected to connection part 342. That is, connection part 341 is connected to connection part 342 with core parts 301, 302, 303, and 304, and column part 35.

In core 3, coil 21 is wound around core part 301, coil 22 is wound around core part 302, coil 23 is wound around core part 303, and coil 24 is wound around core part 304. Core part 301 is placed inside coil 21 and extended along center axis 21C. Core part 302 is placed inside coil 22 and extended along center axis 22C. Core part 303 is placed inside coil 23 and extended along center axis 23C. Core part 304 is placed inside coil 24 and extended along center axis 24C.

As shown in FIGS. 1A and 2-4, cross-sections of core parts 301, 302, 303, and 304 perpendicular to direction D1 have elongated circular shapes slenderly extended in direction D3 and having both ends along direction D2 with arcuate shapes. The shapes of the cross sections of core parts 301 to 304 may not necessarily be the above mentioned shapes, and may be other shapes, such as rectangular shapes and rectangular shapes with partly rounded portions, and circular shapes. Each of connection parts 341 and 342 has a rectangular shape with four rounded corners when viewed in direction D1, as shown in, e.g. FIG. 1B, but may not necessarily have this shape.

Column part 35 is extended along direction D2 from a position between core parts 301 and 302 to a position between core parts 303 and 304. Core parts 301 and 303 are arranged in direction D2. Core parts 302 and 304 are arranged in direction D2. Core part 301, column part 35, and core part 302 are arranged in direction D3. Core part 303, column part 35, and core part 304 are arranged in direction D3.

Column part 35 has a function reducing magnetic coupling between coils 2 allowing column part 35 to be located between coils 2. Column part 35 contributes to the relation of coupling coefficient in accordance with the embodiment, which will be detailed later.

In accordance with the embodiment, all of center axis 22C of coil 22, center axis 23C of coil 23, and center axis 24C of coil 24 are extended in direction D1 as well as center axis 21C of coil 21. Coils 21 and 22 are arranged in direction D3 perpendicular to direction D1. Coils 21 and 23 are arranged in direction D2 perpendicular to direction D1. Coils 21 and 24 are arranged in direction D4 perpendicular to direction D1. Coils 22 and 23 are arranged in direction D5 which is perpendicular to direction D1 and different from directions D2 and D3. Coils 21 and 22 are arranged in direction D3. Coils 23 and 24 are arranged in direction D3. Coils 21 and 23 are arranged in direction D2. Coils 22 and 24 are arranged in direction D2. As shown in FIG. 3, width W1 of core parts 301, 302, 303, and 304 in direction D2 are smaller than widths W2 of core parts 301, 302, 303, and 304 in direction D3, therefore allowing coupling coefficients K12, K13, K14, K23, K24, and K34 of reactor 1 to be easily adjusted. Therefore, reactor 1 hardly allows to the electric power conversion efficiency to deteriorate even in the case the rector has a small number of driving phases of the coils and is driven with low load.

Core 3 has opening portions 351 and 352 provided therein. Opening portion 351 is surrounded by core parts 301 and 303 and connection parts 341 and 342, and opens in direction D3. Opening portion 352 is surrounded by core parts 302 and 304 and connection parts 341 and 342, and opens in direction D3. Opening portions 351 and 352 are arranged in direction D3. Column part 35 is located between opening portions 351 and 352. A part of coil 21 wound around core part 301 and a part of coil 23 wound around core part 303 pass through opening portion 351. A part of coil 22 wound around core part 302 and a part of coil 24 wound around core part 304 pass through opening portion 352.

Core 3 has through-holes 361 and 362 therein penetrating in direction D2. Through-holes 361 and 362 are arranged such that column part 35 is located in between along direction D3. Through-hole 361 is a part of a space surrounded by core parts 301 and 303, column part 35, and connection parts 341 and 342. Through-hole 362 is a part of a space surrounded by core parts 302 and 304, column part 35, and connection parts 341 and 342. A part of coil 21 wound around core part 301 and a part of coil 23 wound around core part 303 pass through through-hole 361. Apart of coil 22 wound around core part 302 and a part of coil 24 wound around core part 304 pass through through-hole 362.

In accordance with the embodiment, core 3 is unitarily formed. The term “unitarily” is not necessarily limited to a unitarily formed configuration, but includes a configuration in which plural components are bonded to one another with, e.g. adhesives. Core 3 is preferably made of magnetic metallic material. Core 3 is made of, e.g. pressurized powder magnetic core (dust core) containing alloy, such as iron-silicon-aluminum (Fe—Si—Al), iron-nickel (Fe—Ni), and iron-silicon (Fe—Si).

Column part 35 of core 3 is not placed inside of any of coils 21, 22, 23, and 24, and is placed outside of all of coils 21, 22, 23, and 24. Coils 21 and 23 are located on the same side with respect to plane P35 which is perpendicular to direction D3 and which crosses column part 35 of core 3. Coils 22 and 24 are located on the same side with respect to plane P35 and on an opposite side to coils 21 and 23 with respect to plane P35. Coil 21 faces coil 23 across no magnetic substance, such as core 3 disposed between coil 21 and coil 23. Coil 22 faces coil 24 across no magnetic substance, such as core 3 disposed between coil 22 and coil 24. Coils 22 and 24 face coils 21 and 23 across column part 35, respectively. As shown in FIG. 4, straight line S14 crossing center axis 21C of coil 21 and center axis 24C of coil 24 crosses straight line S23 crossing center axis 22C of coil 22 and center axis 23C of coil 23 at column part 35 when viewed in direction D1. Straight lines S14 and S23 are perpendicular to direction D1. That is, straight line S14 crosses straight line S23 at column part 35 when viewed in direction D1. Straight line S14 crosses center axes 21C and 24C of coils 21 and 24, and is perpendicular to direction D1. Straight line S23 crosses center axes 22C and 23C of coils 22 and 23, and is perpendicular to direction D1. This configuration allows coupling coefficients K12, K13, K14, K23, K24, and K34 of reactor 1 to be adjusted readily. Thus, even when reactor 1 is driven at low load, the electric power conversion efficiency less deteriorates.

As long as coupling coefficients K12, K13, K14, K23, K24, and K34 of reactor 1 satisfy the above formulae (1) and (2), the position of column part 35 is not limited. In this case, a straight line crossing center axes 21C of and 24C of coils 21 and 24 may not necessarily cross a straight line crossing center axes 22C and 23C of coils 22 and 23 at column part 35 when viewed in direction D1.

Configurations of coils 2 (coils 21-24) of reactor 1 in accordance with the embodiment will be described below.

Coil 21 includes a conductive wire with a rectangular cross section wound around core part 301 about center axis 21C. Coil 22 includes a conductive wire with a rectangular cross section wound around core part 302 about center axis 22C. Coil 23 includes a conductive wire with a rectangular cross section wound around core part 303 about center axis 23C. Coil 24 includes a conductive wire with a rectangular cross section wound around core part 304 about center axis 24C.

Coils 21, 22, 23, and 24 are wound in elongated circular shapes when viewed in direction D1 of center axes 21C, 22C, 23C, and 24C (see FIG. 4). The number of windings of coil 21, the number of windings of coil 22, the number of windings of coil 23, and the number of windings of coil 24 are identical to one another. The number of windings of coil 21, the number of windings of coil 22, the number of windings of coil 23, and the number of windings of coil 24 may be appropriately changed depending on designs. The number of windings of coil 21, the number of windings of coil 22, the number of windings of coil 23, and the number of windings of coil 24 may be different from one another. Each of coils 21, 22, 23, and 24 is not necessarily made to a conductive wire with a rectangular cross section, but may be made of a conductive wire with a circular cross section.

When an electric current flows in at least one of coils 2 (coils 21, 22, 23, and 24), a magnetic flux (DC magnetic flux) is generated from the coil in which an electric current flows. Directions of DC magnetic flux generated by coils 21, 22, and 23, and coil 24 are determined by respective winding directions of coils 21, 22, 23, and 24, and by the directions of electric currents flowing in coils 21, 22, 23, and 24. The DC magnetic flux here is a magnetic flux generated by the DC electric current flowing in each of coils 21, 22, 23, and 24. In accordance with the embodiment, coils 21 and 22 are wound in winding directions identical to each other.

Core 3 constitutes coupling magnetic paths L12, L13, L14, L23, L24, and L34 in which a magnetic flux generated by each of energized coils 21, 22, 23 and 24 passes. These coupling magnetic paths include core parts 301, 302, 303, and 304, and connection parts 341 and 342. Coils 21 and 22 are magnetically coupled to each other by coupling magnetic path L12 in core 3. Coils 21 and 23 are magnetically coupled to each other by coupling magnetic path L13 in core 3. Coils 21 and 24 are magnetically coupled to each other by coupling magnetic path L14 in core 3. Furthermore, coils 22 and 23 are magnetically coupled to each other by coupling magnetic path L23 in core 3. Coils 22 and 24 are magnetically coupled to each other by coupling magnetic path L24 in core 3. Coils 23 and 24 are magnetically coupled to each other by coupling magnetic path L34 in core 3. In other words, core 3 magnetically couples coils 21 and 22 to each other, magnetically couples coils 21 and 23 to each other, magnetically couples coils 21 and 24 to each other, magnetically couples coils 22 and 23 to each other, magnetically couples coils 22 and 24 to each other, and magnetically couples coils 23 and 24 to each other. Therefore, in reactor 1, at least one of core parts 301, 302, 303, and 304 of core 3 provides an inductor function of storing and releasing magnetic energy generated by at least one of coils 21, 22, 23, and 24.

Coils 21, 22, 23, and 24 are wound around core parts 301, 302, 303, and 304, respectively. Therefore, magnetic fluxes generated by coils 21, 22, 23, and 24 pass through plural magnetic paths (core parts 301, 302, 303, and 304, connection parts 341 and 342, and column part 35) in core 3. Thus, for example, when an electric current flows in coil 21 and generates a magnetic flux from coil 21, coils 21 and 22 are magnetically coupled to each other, coils 21 and 23 magnetically coupled to each other, and coils 21 and 24 are magnetically coupled to each other. When an electric current flows in coil 22 and generates a magnetic flux from coil 22, coils 22 and 23 are magnetically coupled to each other, coils 22 and 24 are magnetically coupled to each other, and coils 22 and 21 are magnetically coupled to each other. When an electric current flows in coil 23 and generates a magnetic flux from coil 23, coils 23 and 21 are magnetically coupled to each other, coils 23 and 22 are magnetically coupled to each other, and coils 23 and 24 are magnetically coupled to each other. When an electric current flows in coil 24, and a magnetic flux is generated from coil 24, coils 24 and 21 are magnetically coupled to each other, coils 24 and 22 are magnetically coupled to each other, and coils 24 and 23 are magnetically coupled to each other. Core 3 thus has a magnetic coupling function of magnetically coupling two coils out of plural coils 2 to each other.

Core 3 of reactor 1 includes plural magnetic paths through which magnetic fluxes generated by coils 2 (coils 21, 22, 23, and 24) pass. The magnetic paths of core 3 include coupling magnetic paths and non-coupling magnetic paths. The coupling magnetic paths provide magnetic flux coupling between one coil and the other coil by the magnetic fluxes generated by coils 21, 22, 23, and 24. The coupling magnetic paths include coupling magnetic path L12 passing through the inside of coil 21 and the inside of coil 22, coupling magnetic path L13 passing through the inside of coil 21 and the inside of coil 23, and coupling magnetic path L14 passing through the inside of coil 21 and the inside of coil 24. The coupling magnetic paths further include coupling magnetic path L23 passing through the inside of coil 22 and the inside of coil 23, coupling magnetic path L24 passing through the inside of coil 22 and the inside of coil 24, and coupling magnetic path L34 passing through the inside of coil 23 and the inside of coil 24. The non-coupling magnetic paths do not provide a magnetic flux coupling formed between one coil 2 and any other coils 2 by magnetic flux generated by one coil 2 out of plural coils 2.

In core 3, for example, core part 301 constitutes magnetic path P1. A magnetic flux generated by energized coil 21 passes through magnetic path P1 (see, for example, FIGS. 5A-5C). That is, magnetic path P1 is a path through which a magnetic flux generated by coil 21 passes. Magnetic path P1 includes coupling magnetic paths L12, L13, and L14.

Magnetic path P1 passes through, for example, core part 301 placed inside coil 21, connection part 341, core part 303 placed inside coil 23, and connection part 342. When an electric current flows in coil 21, as shown in FIG. 5A, magnetic flux Y13 is generated. Magnetic path P1 further passes through, for example, core part 301 placed inside coil 21, connection part 341, column part 35, core part 302 placed inside coil 22, and connection part 342. When an electric current flows in coil 21, as shown in FIG. 5B, magnetic fluxes Y11 and Y12 are generated. Magnetic path P1 further passes through, for example, core part 301 placed inside coil 21, connection part 341, column part 35, core part 304 placed inside coil 24, and connection part 342. When an electric current flows in coil 21, as shown in FIG. 5C, magnetic fluxes Y10 and Y14 are generated. That is, magnetic path P1 includes paths through which magnetic fluxes Y10, Y11, Y12, Y13, and Y14 pass. Magnetic fluxes Y10, Y11, Y12, Y13, and Y14 are just schematically shown, and a magnetic flux passing through magnetic path P1 is not necessarily limited thereto.

Core part 302 of core 3 further constitutes magnetic path P2 through which a magnetic flux passes. The magnetic flux is generated when coil 22 is energized. That is, magnetic path P2 is a path through which a magnetic flux generated by coil 22 passes. Magnetic path P2 includes coupling magnetic paths L12, L23, and L24. Magnetic path P2 passes through core part 302 placed inside coil 22, connection part 341, column part 35, core part 301 placed inside coil 21, and connection part 342. Magnetic path P2 further passes through core part 302 placed inside coil 22, connection part 341, column part 35, core part 303 placed inside coil 23, and connection part 342. Magnetic path P2 further passes through core part 302 placed inside coil 22, connection part 341, core part 304 placed inside coil 24, and connection part 342.

Core part 303 of core 3 constitutes magnetic path P3 through which a magnetic flux passes. The magnetic flux is generated when coil 23 is energized. That is, magnetic path P3 is a path through which a magnetic flux generated by coil 23 passes. Magnetic path P3 includes coupling magnetic paths L13, L24, and L34. Magnetic path P3 passes through core part 303 placed inside coil 23, connection part 341, core part 301 placed inside coil 21, and connection part 342. Magnetic path P3 further passes through core part 303 placed inside coil 23, connection part 341, column part 35, core part 302 placed inside coil 22, and connection part 342. Magnetic path P3 further passes through core part 303 placed inside coil 23, connection part 341, core part 304 placed inside coil 24, and connection part 342.

Core part 304 of core 3 constitutes magnetic path P4 through which a magnetic flux passes. The magnetic flux is generated when coil 24 is energized. That is, magnetic path P4 is a path through which a magnetic flux generated by coil 24 passes. Magnetic path P4 includes coupling magnetic paths L14, L24, and L34. Magnetic path P4 passes through core part 304 placed inside coil 24, connection part 341, column part 35, core part 301 placed inside coil 21, and connection part 342. Magnetic path P4 further passes through core part 304 placed inside coil 24, connection part 341, core part 302 placed inside coil 22, and connection part 342. Magnetic path P4 further passes through core part 304 placed inside coil 24, connection part 341, core part 303 placed inside coil 23, and connection part 342.

In reactor 1 in accordance with the embodiment, as described above, coupling coefficients K12, K13, and K14 satisfy the formula (1), and coupling coefficients K12, K23, and K24 satisfy the formula (2).

The coupling coefficient K13 of coils 21 and 23 is larger than the coupling coefficient K12 of coils 21 and 22, and the coupling coefficient K14 of coils 21 and 24. The coupling coefficient K24 of coils 22 and 24 is larger than the coupling coefficient K12 of coils 21 and 22, and the coupling coefficient K34 of each of coils 23 and 24. That is, the magnetic coupling between coils 21 and 23 is stronger than both of the magnetic coupling between coils 21 and 22 and the magnetic coupling between coils 21 and 24. The magnetic coupling between coils 22 and 24 is stronger than both of the magnetic coupling between coils 21 and 22 and the coupling coefficient of coils 23 and 24. When plural coils 2 of reactor 1 are driven, the effect of the magnetic coupling is obtained even in the case that the number of coils 2 to be driven is small and coils 2 through which electric currents flow is changed. Thus, high DC superimposition effect is obtained, and deterioration of the electric power efficiency due to a switching loss can be suppressed.

Coupling coefficients K13 and K34 may satisfy the relation of K13>K34. Coupling coefficients K24 and K12 may satisfy the relation of K24>K12.

In reactor 1, coupling coefficients K12, K13, and K14 may preferably satisfy the formula (3).

K13>(K12+K13+K14)/2 (3)

In this case, reactor 1 may control the magnetic coupling more, and allow the electric power conversion efficiency to less deteriorate. Reactor 1, satisfying the relation expressed as the formula (3) allows coupling coefficients K12, K23, and K24 to satisfy the formula (3′).

K24>(K12+K23+K24)/2 (3′)

Coupling coefficients K12, K13, and K14 may preferably satisfy the formula (4).

0.3<(K12+K13+K14)<0.7 (4)

In this case, reactor 1 may control the magnetic coupling among plural coils 2 more, and allow the electric power conversion efficiency to less deteriorate. Reactor 1 satisfying the formula (4) allows coupling coefficient K12 and coupling coefficients K23 and K24 to satisfy the formula (4′).

0.3<(K12+K23+K24)<0.7 (4′)

In reactor 1, as the coupling coefficient increases, the magnetic fluxes passing through magnetic paths P1 and P2, P3, and P4 decrease, and an effective inductance of each coil 2 is reduced. Therefore, in the electric power conversion device described below, in order to boost an input voltage up to a predetermined voltage value, the number of windings of each of coils 2 (coils 21, 22, 23, and 24) is increased to increase the inductance. This increases the volume of core 3 to prevent core 3 (core parts 301, 302, 303, and 304, connection parts 341 and 342, and column part 35) from being magnetically saturated, accordingly increasing the size of reactor 1.

In reactor 1 in accordance with the embodiment, coupling coefficients K12, K13, K14, K23, K24, and K34 determined to satisfy the formulae (1) and (2) allows each coupling coefficient to be larger than 0.3 and less than 0.7. Therefore, reactor 1 suppresses the decrease in the inductance of each coil 2, accordingly suppressing the increase of the size of reactor 1. Parameters for determining the coupling coefficient include, e.g. a length of the magnetic path (each coupling magnetic path, and magnetic paths P1 to P4), the cross-sectional area of a magnetic path (each of coupling magnetic paths, and magnetic paths P1 to P4), and materials of core 3.

In reactor 1, the coupling coefficient between coils 2 may be adjusted by, for example, the following method. However, the below-mentioned method for adjusting coupling coefficient is just an example, and is not limited to this method.

Since coupling magnetic path L12 of coils 12 and 22 passes through the inside of both coils 21 and 22, a length of the magnetic path is longer than that of the magnetic path passing through the inside of only one coil 2 (coil 21 or 22) of one of magnetic paths P1 and P2 through which magnetic fluxes generated by coils 21 and 22 pass. Therefore, a longer length of the magnetic path may be a cause for reducing the coupling coefficient. In this accordance with the embodiment, in reactor 1, as described above, coils 21 and 22 are arranged in direction D3 perpendicular to center axes 21C and 22C of coils 21 and 22. Coils 23 and 24 are arranged in direction D2 perpendicular to center axes 23C and 24C of coils 23 and 24. Coils 22 and 24 are arranged in direction D2 perpendicular to center axes 22C and 24C of coils 22 and 24. In this case, a width W1 of each of core parts 301, 302, 303, and 304 in direction D3 may be preferably shorter than a width W2 of each of core parts 301, 302, 303, and 304 in direction D2.

Specifically, as shown in FIG. 3, the width W1 of core parts 301, 302, 303, and 304 in the direction D2 is shorter than the width W2 in the direction D3. In other words, the interval between core parts 301 and 302 and the interval between core parts 301 and 304 are longer than the interval between core parts 301 and 303. The lengths of coupling magnetic paths L12 and L14 are longer than a length of coupling magnetic path L13. These configurations reduces the magnetic resistance of coupling magnetic path L13. Similarly, the interval between core parts 301 and 302 and the interval between core parts 302 and 304 are longer than the interval between core parts 302 and 304, and the lengths of coupling magnetic paths L12 and L24 is be longer than a length of coupling magnetic path L23. This configuration reduces the magnetic resistance of coupling magnetic path L23. These prevents coupling coefficients K13 and K24 from excessively decreasing.

As described above, column part 35 has a function of suppressing the magnetic coupling between coils 2 located such that column part 35 is disposed between the coils 2. Core 3 with column part 35 reduces, e.g. the coupling between coils 21 and 22 and the coupling between coils 21 and 24. Column part 35 reduces the coupling between coils 23 and 24 and the coupling between coils 22 and 23. Column part 35 may be made of material different from those of core parts 301, 302, 303, and 304 of core 3.

### (3) Modified Example

Modified Examples will be described below. The below-mentioned Modified Examples may be applied as appropriate combinations of the above-mentioned embodiment and Modified Example.

In reactor 1 according to the embodiment, at least one of connection parts 341 and 342, core parts 301, 302, 303, and 304, and column part 35 of core 3 are unitarily formed, but each of them may be a component separate from one another. For example, in the above-described example, core part 301 constitutes both coupling magnetic path L12 and magnetic path P1, but may be composed of separate core parts each constituting respective one of coupling magnetic path L12, and magnetic path P1. Core part 302 constitutes both a coupling magnetic path and magnetic path P2, but may be composed of separate core parts each constituting respective one of the coupling magnetic path and the magnetic path. In this case, two core parts forming core part 301 (302) may be bonded to each other with adhesives. Similarly, each of core parts 303 and 304 may be composed of separate core parts each constituting respective one of coupling magnetic paths. Similarly, each of core part 303 and core part 304 may be composed of separate core parts each constituting respective one of the coupling magnetic path and the non-coupling magnetic path.

Core parts 301, 302, 303, and 304 of core 3 may be made of materials different from one another. For example, in designing reactor 1, material of core parts 301 and 302 and material of core parts 303 and 304 may have magnetic permeabilities different from each other to adjust the coupling coefficients.

Reactor 1 may further include a bobbin. Coil 2 (at least one coil selected from the group consisting of coils 21, 22, 23, and 24) is wound around the bobbin, and at least one core part selected from the group consisting of core parts 301, 302, 303, and 304 of core 3 passes through the bobbin.

Reactor 1 may further include a sealing member, such as a resin, that seals coils 21, 22, 23, and 24 and core 3 unitarily. This configuration suppresses winding displacement of coils 21, 22, 23, and 24.

Core 3 may preferably have 180° rotational symmetry with respect to an axis along direction D1, that is, the shape of core 3 coincides with the shape of core 3 rotated by 180° with respect to axis AX3 along direction D1. That is, the shape of core 3 has two-fold rotational symmetry with respect to axis AX3. In this case, each coupling coefficient is easily adjusted so as to satisfy the formulae (1)-(4). Reactor 1 thus improves the effect of suppressing deterioration of electric power conversion even if the number of driving phases of plural coils 2 are changed.

Core 3 may not necessarily have through-holes 361 and 362 provided therein. For example, core 3 may have a rectangular tubular shape with no opening portion, such as through-holes 361 and 362. Through-holes 361 and 362 provided in core 3 may be connected to each other.

Core 3 may not necessarily have opening portions 351 and 352 therein. For example, core 3 may have connection parts 341 and 342, core parts 301, 302, 303, and 304, and a side wall surrounding the connection parts and the core parts.

The number of coils 2 is not limited to four, and may be five or more.

### (4) Electric Power Conversion Device

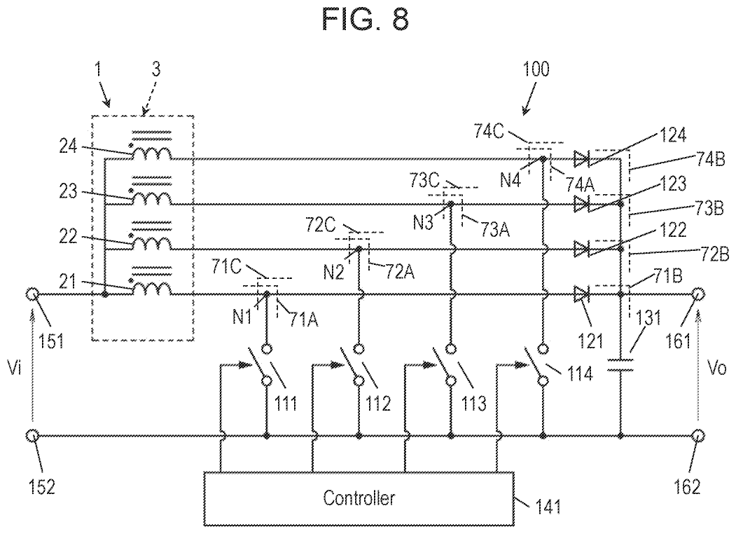

FIG. 8 is a circuit diagram of electric power conversion device 100 including reactor 1 in accordance with the embodiment. Electric power conversion device 100 is installed to, e.g. an automobile, a power conditioner for a dwelling or a non-dwelling, and an electronic device.

Electric power conversion device 100 according to the embodiment includes reactor 1 and controller 141 for controlling energization of coils 21, 22, 23, and 24. The configuration of electric power conversion device 100 is not limited to the following description.

Electric power conversion device 100 according to the embodiment is a multi-phase boost chopper circuit configured to output an output voltage Vo obtained by boosting input voltage Vi. Electric power conversion device 100 includes reactor 1, four switching elements 111, 112, 113, and 114, four diodes 121, 122, 123, and 124, capacitor 131, and controller 141. Electric potential higher than that to input terminal 152 is applied to input terminal 151.

In electric power conversion device 100 according to the embodiment, a DC input voltage Vi is applied across a pair of input terminals 151 and 152. Four series circuit assemblies 71A to 74A are electrically connected parallel to each other between the pair of input terminals 151 and 152. Series circuit assembly 71A includes coil 21 of reactor 1 and switching element 111 connected in series to each other. Series circuit assembly 72A includes coil 22 of reactor 1 and switching element 112 connected in series to each other. Series circuit assembly 73A includes coil 23 of reactor 1 and switching element 113 connected in series to each other. Series circuit assembly 74A includes coil 24 of reactor 1 and switching element 114 connected in series to each other. In accordance with the embodiments, the winding directions of coils 21 and 22 are identical to each other. Respective one ends of coils 21 and 22 are electrically connected to input terminal 151 at a high electric potential side in electric power conversion device 100.

Coils 21, 22, 23, and 24 are magnetically coupled to one another by core 3 as described above.

Switching elements 111, 112, 113, and 114 are implemented by, e.g. a metal oxide semiconductor field effect transistor (MOSFET). One end of switching element 111 is electrically connected to input terminal 151 at a high electric potential side via coil 21, and another end thereof is electrically connected to input terminal 152 at a low electric potential side. One end of switching element 112 is electrically connected to input terminal 151 at a high electric potential side via coil 22, and another end thereof is electrically connected to input terminal 152 at a low electric potential side. One end of switching element 113 is electrically connected to input terminal 151 at a high electric potential side via coil 23, and another end thereof is electrically connected to input terminal 152 at a low electric potential side. One end of switching element 114 is electrically connected to input terminal 151 at a high electric potential side via coil 24, and another end is electrically connected to input terminal 152 at a low electric potential side. Switching elements 111, 112, 113, and 114 are turned on and off by signals supplied from controller 141.

Series circuit assembly 71B including diode 121 and capacitor 131 which are connected in series to each other is electrically connected between both ends of switching element 111. Series circuit assembly 72B including diode 122 and capacitor 131 which are connected in series to each other is electrically connected between both ends of switching element 112. Series circuit assembly 73B including diode 123 and capacitor 131 which are connected in series to each other is electrically connected between both ends of switching element 113. Series circuit assembly 74B including diode 124 and capacitor 131 which are connected in series to each other is electrically connected between both ends of switching element 114. In other words, series circuit assembly 71C including switching element 111 and diode 121 which are connected in series to each other, series circuit assembly 72C including switching element 112 and diode 122 which are connected in series to each other, series circuit assembly 73C including switching element 113 and diode 123 which are connected in series to each other, and series circuit assembly 74C including switching element 114 and diode 124 connected in series to each other are electrically connected in parallel to both ends of capacitor 131 between both ends of capacitor 131.

Capacitor 131 is a smoothing capacitor electrically connected to a pair of output terminals 161 and 162 between output terminals 161 and 162. An anode of diode 121 is electrically connected to node N1 at which coil 21 is connected to switching element 111, and a cathode thereof is electrically connected to capacitor 131. An anode of diode 122 is electrically connected to node N2 at which coil 22 is connected to switching element 112, and a cathode thereof is electrically connected to capacitor 131. An anode of diode 123 is electrically connected to node N3 at which coil 23 is connected to switching element 113, and a cathode thereof is electrically connected to capacitor 131. An anode of diode 124 is electrically connected to node N4 at which coil 24 is connected to switching element 114, and a cathode thereof is electrically connected to capacitor 131.

Controller 141 is configured to control the turning on and off of switching elements 111 and 112, 113, and 114 directly or via a driver circuit. Controller 141 is configured to control the turning on and off of switching elements 111 and 112, 113, and 114, thereby controlling electric currents flowing coils 21, 22, 23, and 24.

When switching element 111 is turned on, an electric current flows in coil 3, and magnetism energy is stored in core 3. When switching element 111 is turned off, magnetic energy stored in core 3 is released, so that an electric current flows into capacitor 131, and capacitor 131 is charged.

An operation when switching elements 112, 113, and 114 are turned on and off allows magnetism energy to be stored in core 3 and charges capacitor 131, similarly to the operation when switching element 111 is turned on and off. When switching elements 111, 112, 113, and 114 are turned on and off, output voltage Vo obtained by boosting input voltage Vi is generated across both ends of capacitor 131.

Controller 141 according to the embodiment has a drive mode including a two-phase drive mode and a four-phase drive mode. That is, the drive mode of controller 141 includes, for example, a two-phase drive mode and a four-phase drive mode.

In the four-phase drive mode, controller 141 controls the switching elements to energize all of coils 21, 22, 23, and 24. Controller 141 controls the switching elements to, for example, sequentially turn on switching elements 111, 112, 113, and 114. In this case, controller 141 controls switching elements 111, 112, and 113, and 114 to shifting the phases of the electric currents flowing in coils 21, 22, 23, and 24 from one another by 90°. Controller 141 thus performs the four-phase drive mode for driving four coils 21, 22, 23, and 24.

Electric power conversion device 100 according to the embodiment may decrease the number of coils driven from that of the above-mentioned four-phase drive mode. Electric power conversion device 100 may be driven in, for example, the two-phase drive mode.

In the two-phase drive mode, controller 141 controls the switching elements to alternately energize only coils 21 and 23 out of coils 21, 22, 23, and 24, and not to energize coils 23 and 24 out of coils 21, 22, 23, and 24. Coils 21 and 23 are alternately energized, but may be simultaneously energized. Controller 141 thus performs the two-phase drive mode. In this case, controller 141 may select two coils 2 as a combination of two coils 2 magnetically coupled strong among four coils 2. For example, an operation in which controller 141 controls the switching elements to alternately energize only coils 21 and 23 out of coils 21 to 24 and not to energize coils 22 and 24 will be described below. However, controller 141 may control the switching elements to alternately energize only coils 22 and 24 out of coils 21-24 and not to energize coils 21 and 23 out of coils 21-24. A combination of coils in which energization is controlled by controller 141 may be appropriately selected.

In the two-phase drive mode, controller 141 may allow an element group including two switching elements out of four switching elements 111, 112, and 113 to be alternately turned on. Controller 141 turns on, for example, two switching elements 111 and 112 out of four switching elements 111-114, and simultaneously turns off the other two switching elements 113 and 114. Next, controller 141 turns off switching elements 111 and 112 and turns on two switching elements 113 and 114 simultaneously to the turning off of the other two switching elements 111 and 112. By repeating these alternately, controller 141 controls switching elements 111, 112, 113, and 114. In this case, controller 141 controls switching elements 111 and 112, 113, and 114 to shift the phases of electric currents flowing in coils 21 and 22 by 180° from the phase of electric currents flowing in coils 23 and 24. Controller 141 thus performs the two-phase drive for driving two coils out of the pair of coils 21 and 22 and the pair of coils 23 and 24.

In electric power conversion device 100 including reactor 1 with, e.g. four coils 2, controller 141 that controls electric currents flowing in the four coils is configured to shift the phases of electric currents flowing in four coils 2 by 90°.

A configuration of an electric circuit in electric power conversion device 100 including reactor 1 is not limited to a multi-phase booster chopper circuit (see FIG. 8).

In electric power conversion device 100 according to the embodiment, capacitor 131 is charged and discharged repetitively at a period that is twice the switching period of switching elements 111 and 112 in the two-phase drive. In electric power conversion device 100, capacitor 131 is repetitively charged and discharged at a period that is four times the switching period of switching elements 111 and 112 in the four-phase drive. Electric power conversion device 100 allows capacitor 131 to have a small size. In electric power conversion device 100 according to the exemplary embodiment, even in two-phase drive, the electric power conversion efficiency hardly deteriorates. Therefore, electric power conversion device 100 including reactor 1 may be suitably used in, e.g. an automobile, a power conditioner for a dwelling or a non-dwelling, and an electronic apparatus.

Reactor 1 suppress the increase of its size and provides each coil 2 with an inductance to boost up input voltage Vi to a predetermined voltage value in electric power conversion device 100.

### REFERENCE MARKS IN THE DRAWINGS

1 reactor
2 coil
21 coil (first coil)
22 coil (second coil)
23 coil (third coil)
24 coil (fourth coil)
3 core
35 column part
301 core part (first core part)
302 core part (second core part)
303 core part (third core part)
304 core part (fourth core part)
100 electric power conversion device
141 controller

1. A reactor comprising:
a core; and
a first coil, a second coil, a third coil, and a fourth coil wound around the core and magnetically coupled to one another, wherein
a coupling coefficient K12 between the first coil and the second coil, a coupling coefficient K13 between the first coil and the third coil, and a coupling coefficient K14 between the first coil and the fourth coil satisfy relations K13>K12 and K13>K14, and
a coupling coefficient K23 between the second coil and the third coil, a coupling coefficient K24 between the second coil and the fourth coil, and a coupling coefficient K34 between the third coil and the fourth coil satisfy relations K24>K23 and K24>K34.

2. The reactor according to claim 1, wherein the coupling coefficient K12, the coupling coefficient K13, and the coupling coefficient K14 satisfy a relation K13>(K12+K13+K14)/2.

3. The reactor according to claim 1, wherein the coupling coefficient K12, the coupling coefficient K13, and the coupling coefficient K14 satisfy a relation 0.3<(K12+K13+K14)<0.7.

4. The reactor according to claim 1, wherein
a center axis of the first coil, a center axis of the second coil, a center axis of the third coil, and a center axis of the fourth coil are extended in a first direction,
the first coil and the third coil are arranged in a second direction perpendicular to the first direction,
the second coil and the fourth coil are arranged in the second direction,
the first coil and the second coil are arranged in a third direction perpendicular to the first direction and the second direction,
the third coil and the fourth coil are arranged in the third direction,
the core includes:
a first core part placed inside the first coil;
a second core part placed inside the second coil;
a third core part placed inside the third coil; and
a fourth core part placed inside the fourth coil,
a width of the first core part in the second direction is shorter than a width of the first core part in the third direction,
a width of the second core part in the second direction is shorter than a width of the second core part in the third direction,
a width of the third core part in the second direction is shorter than a width of the third core part in the third direction, and
a width of the fourth core part in the second direction is shorter than a width of the fourth core part in the third direction.

5. The reactor according to claim 1, wherein
the center axis of the first coil, the center axis of the second coil, the center axis of the third coil, and the center axis of the fourth coil are extended in the first direction,
the first coil and the second coil are arranged in a direction perpendicular to the first direction,
the first coil and the third coil are arranged in a direction perpendicular to the first direction,
the first coil and the fourth coil are arranged in a direction perpendicular to the first direction,
the core includes:
a first core part placed inside the first coil;
a second core part placed inside the second coil;
a third core part placed inside the third coil;
a fourth core part placed inside the fourth coil; and
a column part placed outside all of the first coil, the second coil, the third coil, and the fourth coil, and
a straight line crossing the center axis of the first coil and the center axis of the fourth coil crosses a straight line crossing the center axis of the second coil and the center axis of the third coil at the column part of the core when viewed in the first direction.

6. The reactor according to claim 5, wherein
the first coil faces the third coil across no magnetic substance,
the second coil faces the fourth coil across no magnetic substance,
the second coil and the fourth coil face the first coil and the third coil across the column part of the core, respectively.

7. The reactor according to claim 5, wherein
the column part is extended in the first direction,
the core further includes:
a first connection part connected to respective one ends of the first core part, the second core part, the third core part, the fourth core part, and the column part along the first direction; and
a second connection part connected to respective another ends of the first core part, the second core part, the third core part, the fourth core part, and the column part along the first direction.

8. A reactor comprising:
a core; and
a first coil, a second coil, a third coil, and a fourth coil wound around the core and magnetically coupled to one another, wherein
a center axis of the first coil, a center axis of the second coil, a center axis of the third coil, and a center axis of the fourth coil are extended in a first direction, the first coil and the third coil are arranged in a second direction perpendicular to the first direction,
the second coil and the fourth coil are arranged in the second direction,
the first coil and the second coil are arranged in a third direction perpendicular to the first direction and the second direction,
the third coil and the fourth coil are arranged in the third direction,
the core includes:
a first core part placed inside the first coil;
a second core part placed inside the second coil;
a third core part placed inside the third coil; and
a fourth core part placed inside the fourth coil,
a width of the first core part in the second direction is shorter than a width of the first core part in the third direction,
a width of the second core part in the second direction is shorter than a width of the second core part in the third direction,
a width of the third core part in the second direction is shorter than a width of the third core part in the third direction, and
a width of the fourth core part in the second direction is shorter than a width of the fourth core part in the third direction.

9. A reactor comprising:
a core; and
a first coil, a second coil, a third coil, and a fourth coil wound around the core and magnetically coupled to one another, wherein
a center axis of the first coil, a center axis of the second coil, a center axis of the third coil, and a center axis of the fourth coil are extended in a first direction,
the first coil and the second coil are arranged in a direction perpendicular to the first direction,
the first coil and the third coil are arranged in a direction perpendicular to the first direction,
the first coil and the fourth coil are arranged in a direction perpendicular to the first direction,
the core includes:
a first core part placed inside the first coil;
a second core part placed inside the second coil;
a third core part placed inside the third coil;
a fourth core part placed inside the fourth coil; and
a column part placed outside all of the first coil, the second coil, the third coil, and the fourth coil, and
a straight line crossing the center axis of the first coil and the center axis of the fourth coil crosses a straight line crossing the center axis of the second coil and the center axis of the third coil at the column part of the core when viewed in the first direction.

10. The reactor according to claim 9, wherein
the first coil faces the third coil across no magnetic substance,
the second coil faces the fourth coil across no magnetic substance, and
the second coil and the fourth coil face the first coil the third coil across the column part of the core, respectively.

11. The reactor according to claim 9, wherein
the column part is extended in the first direction,
the core further includes:
a first connection part connected to respective one ends of the first core part, the second core part, the third core part, the fourth core part, and the column part along the first direction; and
a second connection part connected to respective another ends of the first core part, the second core part, the third core part, the fourth core part, and the column part along the first direction.

12. The reactor according to claim 9, wherein the core further includes:
a first connection part connected to respective one ends of the first core part, the second core part, the third core part, and the fourth core part along the first direction; and
a second connection part connected to respective another ends of the first core part, the second core part, the third core part, and the fourth core part along the first direction.

13. The reactor according to claim 9, wherein the core has a shape having two-fold rotational symmetry with respect to an axis along the first direction.

14. A reactor comprising:
a core; and
a first coil, a second coil, a third coil, and a fourth coil wound around the core and magnetically coupled to one another,
a center axis of the first coil, a center axis of the second coil, a center axis of the third coil, and a center axis of the fourth coil are extended in the first direction,
the first coil and the second coil are arranged in a direction perpendicular to the first direction,
the first coil and the third coil are arranged in a direction perpendicular to the first direction,
the first coil and the fourth coil are arranged in a direction perpendicular to the first direction,
the core includes:
a first core part placed inside the first coil;
a second core part placed inside the second coil;
a third core part placed inside the third coil;
a fourth core part placed inside the fourth coil; and
a column part placed outside all of the first coil, the second coil, the third coil, and the fourth coil, and
a straight line crossing the center axis of the first coil and the center axis of the fourth coil crosses a straight line crossing the center axis of the second coil and the center axis of the third coil at the column part of the core when viewed in the first direction.

15. The reactor according to claim 14, wherein
the first coil faces the third coil across no magnetic substance,
the second coil faces the fourth coil across no magnetic substance, and
the second coil and the fourth coil face the first coil and the third coil across the column part of the core, respectively.

16. The reactor according to claim 14, wherein
the column part is extended in the first direction,
the core further includes:
a first connection part connected to respective one ends of the first core part, the second core part, the third core part, the fourth core part, and the column part along the first direction; and
a second connection part connected to respective another ends of the first core part, the second core part, the third core part, the fourth core part, and the column part along the first direction.

17. The reactor according to claim 14, wherein the core has a shape having two-fold rotational symmetry with respect to an axis along the first direction.

18. An electric power conversion device comprising:
a reactor according to claim 1; and
a controller for controlling energization of the first coil, the second coil, the third coil, and the fourth coil of the reactor.

19. The electric power conversion device according to claim 18, wherein the controller is configured to:
control energization of the first coil, the second coil, the third coil, and the fourth coil in a two-phase drive mode of energizing only the first coil and the third coil among the first coil, the second coil, the third coil, and the fourth coil; and
control energization to the first coil, the second coil, the third coil, and the fourth coil in a four-phase drive mode of energizing all of the first coil, the second coil, the third coil, and the fourth coil.

20. The reactor according to claim 4, wherein
the core further includes a column part placed outside all of the first coil, the second coil, the third coil, and the fourth coil, and
a straight line crossing the center axis of the first coil and the center axis of the fourth coil crosses a straight line crossing the center axis of the second coil and the center axis of the third coil at the column part of the core when viewed in the first direction.

21. The reactor according to claim 20, wherein
the first coil faces the third coil across no magnetic substance,
the second coil faces the fourth coil across no magnetic substance,
the second coil and the fourth coil face the first coil and the third coil across the column part of the core, respectively.

22. The reactor according to claim 20, wherein
the column part is extended in the first direction,
the core further includes:
a first connection part connected to respective one ends of the first core part, the second core part, the third core part, the fourth core part, and the column part along the first direction; and
a second connection part connected to respective another ends of the first core part, the second core part, the third core part, the fourth core part, and the column part along the first direction.

23. The reactor according to claim 8, wherein the core further includes:
a first connection part connected to respective one ends of the first core part, the second core part, the third core part, and the fourth core part along the first direction; and
a second connection part connected to respective another ends of the first core part, the second core part, the third core part, and the fourth core part along the first direction.

24. The reactor according to claim 8, wherein the core has a shape having two-fold rotational symmetry with respect to an axis along the first direction.

25. An electric power conversion device comprising:
a reactor according to claim 8; and
a controller for controlling energization of the first coil, the second coil, the third coil, and the fourth coil of the reactor.

26. The electric power conversion device according to claim 25, wherein the controller is configured to:
control energization of the first coil, the second coil, the third coil, and the fourth coil in a two-phase drive mode of energizing only the first coil and the third coil among the first coil, the second coil, the third coil, and the fourth coil; and
control energization to the first coil, the second coil, the third coil, and the fourth coil in a four-phase drive mode of energizing all of the first coil, the second coil, the third coil, and the fourth coil.

27. An electric power conversion device comprising:
a reactor according to claim 9; and
a controller for controlling energization of the first coil, the second coil, the third coil, and the fourth coil of the reactor.

28. The electric power conversion device according to claim 27, wherein the controller is configured to:
control energization of the first coil, the second coil, the third coil, and the fourth coil in a two-phase drive mode of energizing only the first coil and the third coil among the first coil, the second coil, the third coil, and the fourth coil; and
control energization to the first coil, the second coil, the third coil, and the fourth coil in a four-phase drive mode of energizing all of the first coil, the second coil, the third coil, and the fourth coil.

29. An electric power conversion device comprising:
a reactor according to claim 14; and
a controller for controlling energization of the first coil, the second coil, the third coil, and the fourth coil of the reactor.

30. The electric power conversion device according to claim 29, wherein the controller is configured to:
control energization of the first coil, the second coil, the third coil, and the fourth coil in a two-phase drive mode of energizing only the first coil and the third coil among the first coil, the second coil, the third coil, and the fourth coil; and
control energization to the first coil, the second coil, the third coil, and the fourth coil in a four-phase drive mode of energizing all of the first coil, the second coil, the third coil, and the fourth coil.
